(19) United States
(12) Patent Application Publication
(10) Pub. No.: US 2017/0192694 A1
(43) Pub. Date: Jul. 6, 2017

(54) MOVEMENT-DRIVEN SELECTION OF A DATA STORAGE LOCATION OR DEVICE

(71) Applicant: Lenovo Enterprise Solutions (Singapore) Pte. Ltd., Singapore (SG)

(72) Inventors: Shareef F. Alshinnawi, Apex, NC (US); Gary D. Cudak, Wake Forest, NC (US); Joseph F. Herman, Raleigh, NC (US); William M. Megarity, Raleigh, NC (US); J. Mark Weber, Wake Forest, NC (US)

(21) Appl. No.: 14/989,527

(22) Filed: Jan. 6, 2016

(51) Int. Cl. G06F 3/06; G06F 12/08

(52) U.S. Cl. CPC G06F 3/0616; G06F 12/0866; G06F 3/0619; G06F 3/0643; G06F 3/0653; G06F 3/0656; G06F 3/0685; G06F 2212/1036; G06F 2212/21; G06F 2212/281; G06F 2212/222; G06F 2212/463; G06F 2212/603

(57) ABSTRACT

A method includes identifying a movement event that will cause a computer to limit access to a first data storage device of the computer, wherein the first data storage device has internal moving parts. The method further includes identifying an application or file stored on the first data storage device that is to be accessed during a duration of the movement event, and caching or storing the identified application or file on a second data storage device of the computer prior to the movement event, wherein the second data storage device is a solid state device. Still further, the method includes accessing the identified application or file from the second data storage device for the duration of the movement event.

### BACKGROUND

Field of the Invention

The present invention relates to methods of operating a computer during vibration or shocks that may damage a hard drive of the computer.

Background of the Related Art

Mobile computers that include a hard drive, such as a laptop or notebook computer, may implement active hard drive protection, which locks or unloads the drive heads when vibrations are detected so that the disk platters are protected from damage. In one example, a hard drive active protection system (HDAP) is integrated onto a system board for a notebook computer and has a sensor to monitor the notebook computer for unstable situations that could potentially damage the hard drive installed in the notebook's primary hard drive slot. When the HDAP detects a situation that could cause damage to the hard drive, such as dropping the notebook computer, the HDAP will quickly stop the hard drive from spinning and move the hard drive heads to a safe area that does not contain data. The hard drive is less vulnerable to damage when it is not in operation. The protection system turns the hard drive on again once the shock sensor detects a stable environment, such as evidenced by minimal change in system lift, vibration, or shock.

The HDAP system physically monitors the system for tilt, motion and vibration in an effort to prevent physical hard drive damage if the system receives a physical shock, such as a drop to the floor. When the HDAP system detects that the motion of the notebook computer is greater than an expected value, the HDAP system will quickly stop the hard drive from spinning, and will move the read/write heads of the hard drive to an area that does not contain data. The shock and vibration tolerance of a hard drive increases up to four times if the hard drive head is unloaded. During the time that the HDAP system has unloaded the hard drive heads due to tilt/drop motion being detected to the system, the system will not be able to access the hard drive. This can result in the operating system appearing to be temporarily sluggish or non-responsive. When the unstable environment has become stable again (i.e., the potentially damaging motion is no longer detected), the HDAP system will start the hard drive again, and the system will perform normally. Typically, the HDAP system needs a few seconds to spin the hard drive up after the environment has become stable again.

While the HDAP is beneficial for protecting the hard drive from damage, the temporary lack of access to the drive contents, while moving or in an environment with frequent movement (i.e., in a train, bus, car, or plane), can significantly slow down an application or process that relies upon the access to the drive contents. Therefore, one HDAP allows a user to temporarily suspend or override operation of the HDAP during motion that is deemed to not pose a threat of damage to the hard drive.

### BRIEF SUMMARY

One embodiment of the present invention provides a method comprising identifying a movement event that will cause a computer to limit access to a first data storage device of the computer, wherein the first data storage device has internal moving parts. The method further comprises identifying an application or file stored on the first data storage device to be accessed during a duration of the movement event, and caching or storing the identified application or file on a second data storage device of the computer prior to the movement event, wherein the second data storage device is a solid state device. Still further, the method comprises accessing the identified application or file from the second data storage device for the duration of the movement event.

Another embodiment of the present invention provides a computer program product comprising a computer readable storage medium having non-transitory program instructions embodied therewith, wherein the program instructions are executable by a processor to cause the processor to perform a method. The method comprises identifying a movement event that will cause a computer to limit access to a first data storage device of the computer, wherein the first data storage device has internal moving parts. The method further comprises identifying an application or file stored on the first data storage device to be accessed during a duration of the movement event, and caching or storing the identified application or file on a second data storage device of the computer prior to the movement event, wherein the second data storage device is a solid state device. Still further, the method comprises accessing the identified application or file from the second data storage device for the duration of the movement event.

### BRIEF DESCRIPTION OF THE SEVERAL VIEWS OF THE DRAWINGS

FIG. 1 is a diagram of a computer according with one embodiment of the present invention.

FIG. 2 is a flowchart of a method according to another embodiment of the present invention.

FIG. 3 is a schematic diagram illustrating how a user calendar or history may be used to identify expected movement events and expected application or file use in accordance with one or more embodiments of the present invention.

### DETAILED DESCRIPTION

One embodiment of the present invention provides a method comprising identifying a movement event that will cause a computer to limit access to a first data storage device of the computer, wherein the first data storage device has internal moving parts. The method further comprises identifying an application or file stored on the first data storage device to be accessed during a duration of the movement event, and caching or storing the identified application or file on a second data storage device of the computer prior to the movement event, wherein the second data storage device is a solid state device. Still further, the method comprises accessing the identified application or file from the second data storage device for the duration of the movement event.

A computer may monitor movement events using a hard drive active protection system (HDAP), such that a movement event that will cause a computer to limit access to a hard drive may be referred to as an HDAP event or HDAP period. Optionally, a movement event that will cause a computer to limit access to a first data storage device, such as a hard drive, may be characterized by vibration frequencies or intensities. Such a movement event may be identified in one or more of the various manners described below. However, existing hard drive active protection systems (HDAP) only identify an actual, current movement event using a motion sensor that is part of the computer in which the hard drive is installed. However, using a motion sensor only identifies a movement event after the movement event has already begun. As a result, identifying movement with a motion sensor may not allow the advanced notice necessary to cache or store an identified application or file on the second data storage device prior to the movement event.

In accordance with embodiments of the present invention, a movement event that will cause a computer to limit access to a first data storage device may be identified, in one option, by accessing scheduled activities in a calendar application and identifying a movement event associated with one or more of the scheduled activities. For example, a calendar application may include a user's daily train commute and may indicate that a movement event is expected during the duration of the train commute each day. Therefore, the first data storage device may not be available during the duration of the train commute, and embodiments of the present invention will cache or store certain applications or files on a second data storage device, rather than the first data storage device, so that those certain applications or files may be accessed during the train commute.

In another option, a movement event that will cause a computer to limit access to a first data storage device may be identified using a history of movement events measured by the computer. Rather than accessing a calendar of scheduled activities to identify a potential movement event, this option uses a history of movement events to identify when the next movement event may occur. For example, if a movement event is detected every morning from 6:00 am to 7:00 am (perhaps during a user's train commute, despite not being on the calendar), then a movement event may be expected each week day from 6:00 am to 7:00 am.

In yet another option, a movement event that will cause a computer to limit access to a first data storage device may be identified by accessing a list of geographic locations and a measure of movement events associated with each geographic location, and determining a current location of the computer. Such a list may be generated by the user's computer over time or by obtaining such a list from another computer or a third party source. In other words, if a computer has a global positioning system (GPS) device, then the computer can store its location each time that a movement event is detected by its motion sensor. Over time, a list of locations known to cause movement events is generated. Since location-specific movement events may not be limited to any particular computer, such a list may be generated by, and shared among, a plurality of computers. For example, information identifying such location-specific movement events may be gathered in a variety of manners, such as crowd sourcing.

In a still further option, a movement event that will cause a computer to limit access to a first data storage device may be identified by reading a user setting that identifies the movement event. Such a user setting may be a one-time manual entry describing the time and duration of the expected movement event, or the user setting may designate a recurring movement event that is expected to occur at certain times or places. Such user setting may be entered through a graphical user interface.

In accordance with other embodiments of the present invention, one or more application or file stored on the first data storage device to be accessed during a duration of the movement event may be identified, in one option, by accessing scheduled activities in a calendar application and identifying an application or file associated with one or more of the scheduled activities. For example, when a calendar identifies a scheduled activity by time and duration, it is possible to identify an application or file that is frequently used at that time or during such scheduled activities. In other words, a user may routinely respond to email messages via an email application and/or catch up on the latest news reports via a web browser during a train commute to work. If the train commute is identified as a movement event that would limit access to the first data storage device of the computer, then the present method may store the email and browser applications or related files on a second data storage device that is not affected by the movement event.

In another option, one or more application or file stored on the first data storage device to be accessed during a duration of the movement event may be identified by reading a history of application or file use. For example, the computer may store a history of application or file use as a function of time and determine a pattern of application or file use. In other words, if the user has a history of using a particular application or file at a certain time of day, then it may be expected that the particular application or file may again be used or needed at the same time of day. Any application that is to be accessed at the same time of day as an expected movement event may be cached or stored on the second data storage device prior to the expected movement event. Furthermore, an application or file that has been used heavily recently may also be identified as an application or file that is to be accessed during the movement event.

In yet another similar option, one or more application or file stored on the first data storage device to be accessed during a duration of the movement event may be identified by reading a user setting that identifies the application or file. For example, a graphical user interface may be used by a user to identify an application or file that should be accessible even during the occurrence of a movement event that may limit access to the first data storage device.

The second data storage device should be a type of data storage device that will not have its access limited by a computer in response to a movement event. For example, the second data storage device may be a solid state memory device, such as one or more flash memory device or random access memory module, and may be internal to the computer or externally connected to the computer, perhaps using a universal serial bus (USB) port.

The identified application or file may be cached or stored on the second data storage device in various ways. For example, if the second data storage device is a solid state memory device having a sufficient amount of available data storage capacity, then the method may store (relocate) the identified application or file on the solid state memory device and delete the application or file from the first data storage device. Accordingly, the application or file will thereafter be accessible on the solid state memory device regardless of a movement event that may limit access to the first data storage device. Optionally, the application or file may be relocated to the solid state memory device for a user-entered fixed period of time before copying the application or file back to the first data storage device. In another example, if the second data storage device is one or more random access memory module, then the method may move another application or file out of the random access memory module, perhaps to a disk cache, to free up a sufficient amount of memory for the application or file, and then cache or store the application or file in the random access memory module. In a further example, the application or file is only temporarily stored on the second data storage device, such that after the movement event is over, the identified application or file is again accessed from the first data storage device and deleted from the second data storage device. Any changes to the application or file that may have been made while the application or file was stored on the second data storage device may be copied back to the first data storage device.

Another embodiment of the present invention provides a computer program product comprising a computer readable storage medium having non-transitory program instructions embodied therewith, wherein the program instructions are executable by a processor to cause the processor to perform a method. The method comprises identifying a movement event that will cause a computer to limit access to a first data storage device of the computer, wherein the first data storage device has internal moving parts. The method further comprises identifying an application or file stored on the first data storage device to be accessed during a duration of the movement event, and caching or storing the identified application or file on a second data storage device of the computer prior to the movement event, wherein the second data storage device is a solid state device. Still further, the method comprises accessing the identified application or file from the second data storage device for the duration of the movement event.

The foregoing computer program products may further include computer readable program code for implementing or initiating any one or more aspects of the methods described herein. Accordingly, a separate description of the methods will not be duplicated in the context of a computer program product.

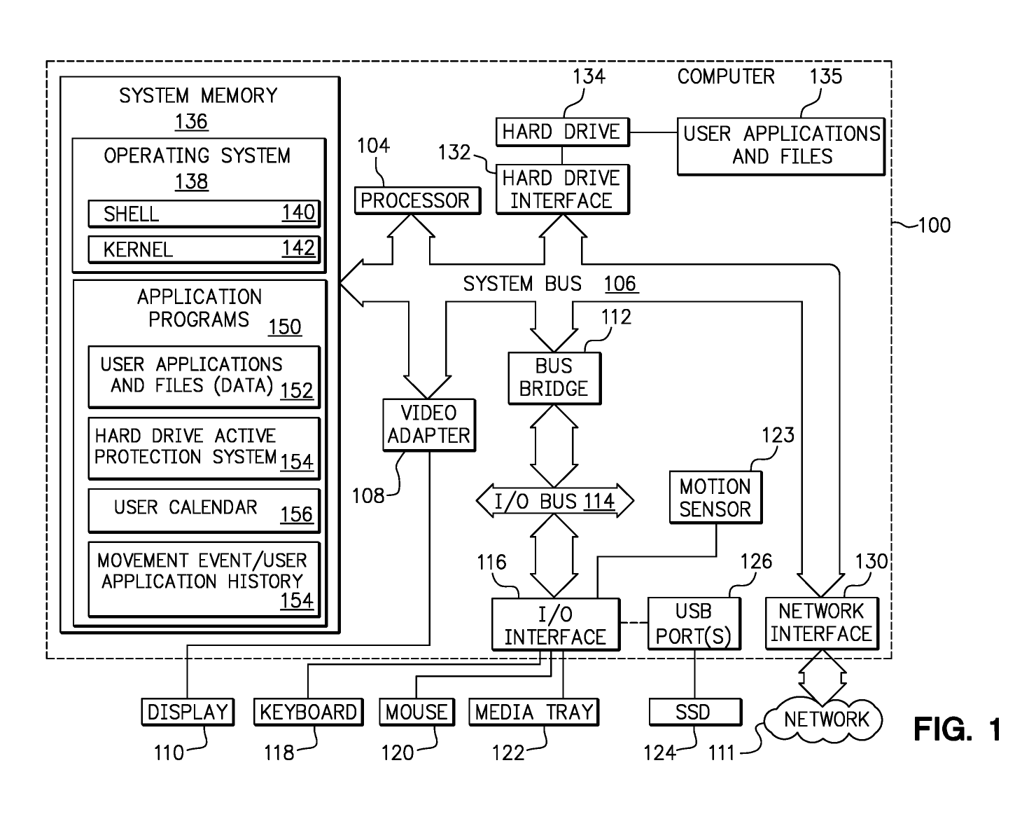

FIG. 1 is a diagram of a computer 100 that is capable of implementing the one or more methods of the present invention. The computer 100 includes a processor unit 104 that is coupled to a system bus 106. The processor unit 104 may utilize one or more processors, each of which has one or more processor cores. A video adapter 108, which drives/supports a display 110, is also coupled to system bus 106. The system bus 106 is coupled via a bus bridge 112 to an input/output (I/O) bus 114. An I/O interface 116 that is coupled to the I/O bus 114 enables communication with various I/O devices, including a keyboard 118, a mouse 120, a media tray 122 (which may include storage devices such as CD-ROM drives, multi-media interfaces, etc.), a motion sensor 123 and USB port(s) 126. A solid state drive (SSD) 124, such as an external flash drive, is connected to one of the USB ports 126. As depicted, the computer 100 is able to communicate with other network devices via the network 111 using a network adapter or network interface controller 130.

A hard drive interface 132 is also coupled to the system bus 106. The hard drive interface 132 interfaces with a hard drive 134. In accordance with various examples, the hard drive 134 is shown to store various user applications and files 135. In a preferred embodiment, the hard drive 134 communicates with system memory 136, which is also coupled to the system bus 106. System memory is defined as a lowest level of volatile memory in the computer 100. This volatile memory includes additional higher levels of volatile memory (not shown), including, but not limited to, cache memory, registers and buffers. Data that populates the system memory 136 includes the operating system (OS) 138 and application programs 150.

The operating system 138 includes a shell 140 for providing transparent user access to resources such as application programs 150. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the operating system 138 also includes the kernel 142, which includes lower levels of functionality for the operating system 138, including providing essential services required by other parts of the operating system 138 and application programs 150, including memory management, process and task management, disk management, and mouse and keyboard management. As shown, the computer 100 includes application programs 150 in the system memory 136. In accordance with one embodiment, the system memory 136 includes, without limitation, user applications and files (data) 152, hard drive active protection system (HDAP) 154, user calendar 156, and movement event/user application history 158. Since the system memory is typically volatile memory, the contents of the system memory 150 may be loaded from the hard drive 134 or other accessible data storage device. The hardware elements depicted in the computer 100 are not intended to be exhaustive, but rather are representative. For instance, the computer 100 may include other data storage devices such as magnetic cassettes, digital versatile disks (DVDs), Bernoulli cartridges, and the like. These and other variations are intended to be within the scope of the present invention.

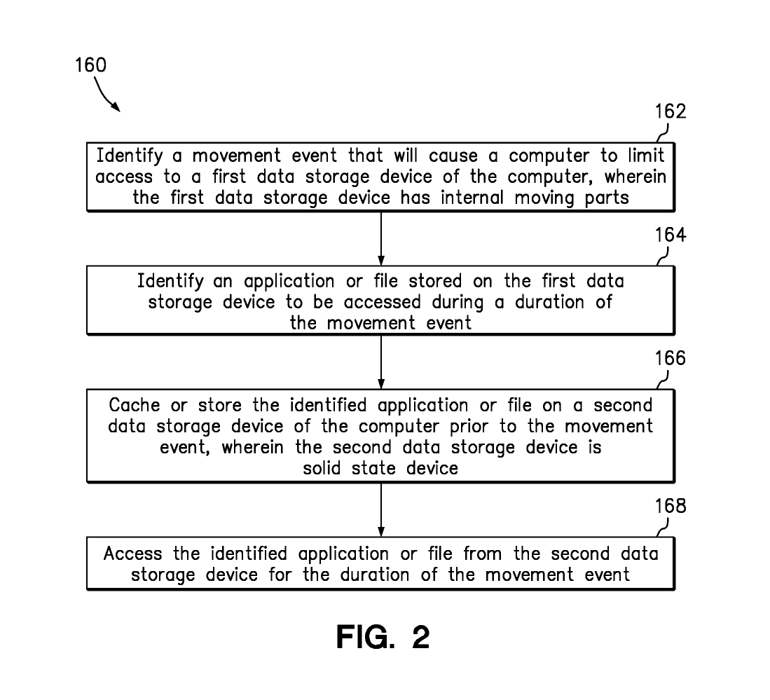

FIG. 2 is a flowchart of a method 160 according to another embodiment of the present invention. In step 162, the method identifies a movement event that will cause a hard drive active protection system of a computer to limit access to a hard drive of the computer. In step 164, the method identifies an application or file stored on the hard drive to be accessed during a duration of the movement event. In step 166, the method caches or stores the identified application or file on a second data storage device of the computer prior to the movement event. Then, in step 168, the method accesses the identified application or file from the second data storage device for the duration of the movement event.

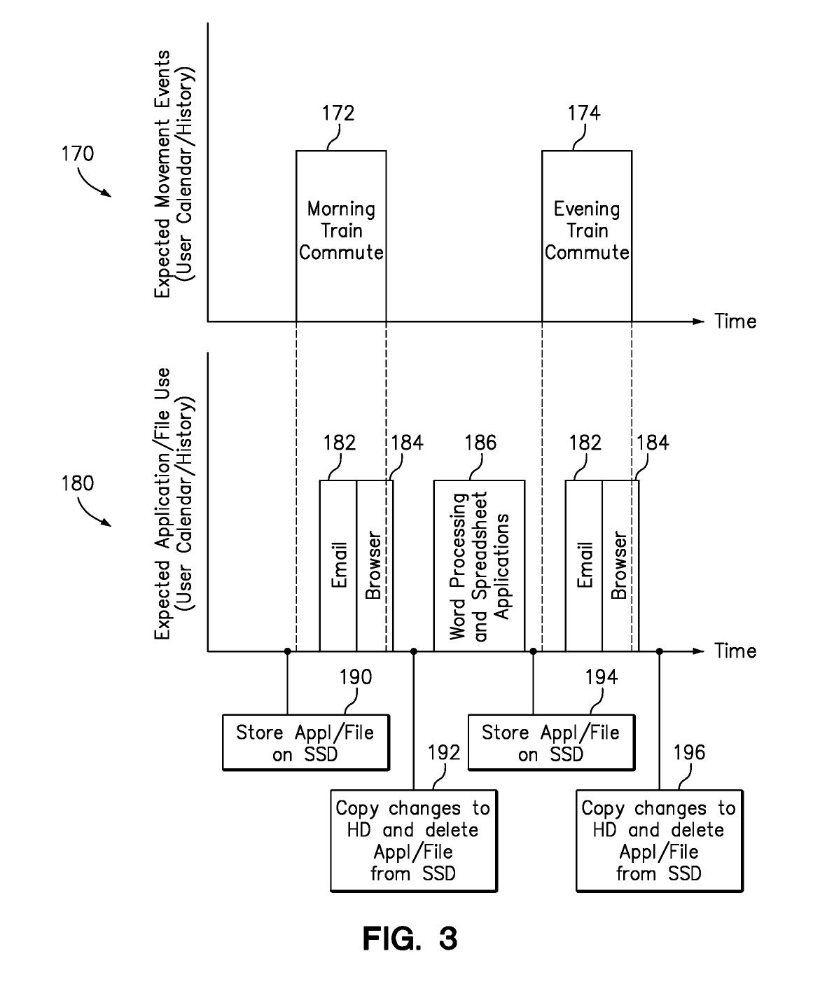

FIG. 3 is a schematic diagram illustrating how a user calendar or history (see user calendar 156 and movement event/user application history 158 in FIG. 1) may be used to identify expected movement events and expected application or file use in accordance with one or more embodiments of the present invention. An upper portion 170 of the diagram illustrates expected movement events that have been identified (per step 162 of FIG. 2) as a function of time using the calendar 156 and/or the history 158. Specifically, the diagram identifies a “morning train commute” (movement event) 172 and an “evening train commute” (movement event) 174, where the width of the movement event illustrates a duration. A lower portion 180 of the diagram illustrates expected application or file use that has been identified (per step 164 of FIG. 2) as a function of time using the calendar 156 and/or the history 158. Using the two timelines, it is shown that an email application 182 and a browser application 184 are expected to be used at some point during the morning train commute 172 and that the same applications 182, 184 are expected to be used again during the evening train commute 174. Vertical dashes lines are used to show how the duration of the expected movement events 172, 174 overlaps with the expected use of the applications 182, 184. Note that the word processing and spreadsheet applications 186 are expected to be used in the middle of the day when no movement events are expected.

A method of the present invention (which may be performed by the hard drive active protection system 154 of FIG. 1 or other logic module, such as the operating system) may store applications or files associated with the email application 182 and the browser application 184 on the solid state device (see solid state device 124 of FIG. 1) at point 190 on the timeline prior to the movement event 172 (per step 166 of FIG. 2). Accordingly, the email application 182 and the browser application 184 may be accessed from the solid state drive 124 for the duration of the movement event 172. At a point 192 on the timeline after the movement event 172 has ended, the method may copy any changes to the hard drive 134 (see FIG. 1) and delete the applications or files from the solid state drive 124. Points 194, 196 on the timeline illustrate that a similar process may be performed with respect to the movement event 174.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage medium (including forms referred to as volatile memory) is, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored as non-transitory program instructions in a computer readable storage medium that can direct a computer, other programmable data processing apparatus, or other devices to function in a particular manner, such that the program instructions stored in the computer readable storage medium produce an article of manufacture including non-transitory program instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
identifying a movement event that will cause a computer to limit access to a first data storage device of the computer, wherein the first data storage device has internal moving parts;
identifying an application or file stored on the first data storage device to be accessed during a duration of the movement event;
caching or storing the identified application or file on a second data storage device of the computer prior to the movement event, wherein the second data storage device is a solid state device; and
accessing the identified application or file from the second data storage device for the duration of the movement event.

2. The method of claim 1, wherein the first data storage device is installed in a mobile computer.

3. The method of claim 1, wherein identifying a movement event that will cause a computer to limit access to a first data storage device, includes accessing scheduled activities in a calendar application and identifying a movement event associated with one or more of the scheduled activities.

4. The method of claim 1, wherein identifying a movement event that will cause a computer to limit access to a first data storage device, includes accessing a history of movement events measured by the computer.

5. The method of claim 1, wherein identifying a movement event that will cause a computer to limit access to a first data storage device, includes accessing a list of geographic locations and a measure of movement events associated with each geographic location, and determining a current location of the computer.

6. The method of claim 5, wherein the list of geographic locations and the measure of movement events associated with each geographic location is obtained from a plurality of other computers sharing movement data.

7. The method of claim 1, wherein identifying a movement event that will cause a computer to limit access to a first data storage device, includes reading a user setting that identifies the movement event.

8. The method of claim 1, wherein identifying an application or file stored on the first data storage device to be accessed during a duration of the movement event, includes accessing events scheduled in a calendar application and identifying an application or file associated with one or more of the movement events.

9. The method of claim 1, wherein identifying an application or file stored on the first data storage device to be accessed during a duration of the movement event, includes accessing events scheduled in a calendar application and identifying an application or file associated with one or more of the movement events.

10. The method of claim 1, wherein identifying an application or file stored on the first data storage device to be accessed during a duration of the movement event, includes reading a history of application or file use.

11. The method of claim 1, wherein identifying an application or file stored on the first data storage device to be accessed during a duration of the movement event, includes reading a user setting that identifies the application or file.

12. The method of claim 1, wherein the solid state device is a flash memory device.

13. The method of claim 12, wherein the flash memory device is an external removable flash memory device.

14. The method of claim 12, wherein caching or storing the identified application or file on a second data storage device for the duration of the movement event, includes storing the application or file on the first data storage device and deleting the application or file from the first data storage device.

15. The method of claim 1, wherein the second data storage device is random access memory.

16. The method of claim 15, further comprising:
moving another application or file out of the random access memory to a disk cache to make room for caching or storing the identified application or file on the random access memory.

17. The method of claim 1, further comprising:
after the movement event is over, accessing the identified application or file from the first data storage device and deleting the identified application or file from the second data storage device.

18. The method of claim 1, wherein the first data storage device is a hard drive.

19. A computer program product comprising a computer readable storage medium having non-transitory program instructions embodied therewith, the program instructions executable by a processor to cause the processor to perform a method comprising:
identifying a movement event that will cause a computer to limit access to a first data storage device of the computer, wherein the first data storage device has internal moving parts;
identifying an application or file stored on the first data storage device to be accessed during a duration of the movement event;
caching or storing the identified application or file on a second data storage device of the computer prior to the movement event, wherein the second data storage device is a solid state device; and
accessing the identified application or file from the second data storage device for the duration of the movement event.

20. The computer program product of claim 19, wherein identifying a movement event that will cause a computer to limit access to a first data storage device of the computer, includes accessing a history of movement events measured by the computer.
